(19) United States
(12) Patent Application Publication
(10) Pub. No.: US 2026/0247495 A1
(43) Pub. Date: Aug. 20, 2026

(54) METHOD FOR PREPARING PLANAR HEATING ELEMENT AND PLANAR HEATING ELEMENT PREPARED BY THE METHOD

(71) Applicant: NEXTONE IND.,INC, Haman-gun (KR)

(72) Inventor: In Sun KO, Changwon-si (KR)

(21) Appl. No.: 18/850,373

(22) PCT Filed: Jun. 16, 2023
(86) PCT No.: PCT/KR2023/008405

§ 371 Date: Sep. 24, 2024

(30) Foreign Application Priority Data
Mar. 31, 2023 (KR) 10-2023-0043103

(51) Int. Cl. H05B 3/26; C03C 17/22

(52) U.S. Cl. CPC H05B 3/26; C03C 17/22; C03C 2217/28; C03C 2218/112

(57) ABSTRACT

The present invention relates to a method for preparing a planar heating element and a planar heating element prepared by the method and the purpose of the present invention is to form a heating layer with excellent electrical characteristics by coating a glass plate with carbon nanotube (CNT) ink and improve electrical stability by increasing the contact surface area with an electrical path through a heating layer with the small physical properties of carbon particles, while minimizing contact resistance with an electric wire. The method for preparing a planar heating element according to the present invention comprises perforating step of drilling at least one hole in a cut glass plate for protruding a wire; printing step of printing conductive materials for allowing electricity to flow on the glass plate; and coating step of coating a heating layer that generates heat on the glass plate.

### TECHNICAL FIELD

The present invention relates to a method for preparing planar heating element and a planar heating element prepared by the method, and more specifically, to a method for preparing planar heating element and a planar heating element prepared by the method, which can form a heating layer with excellent electrical characteristics by coating carbon nanotube (CNT) ink on a glass plate, and can improve electrical characteristics and electrical stability by increasing the contact surface area between the heating layer and an electrical path,

### BACKGROUND ART

In general, planar heating elements are known to have a superior heating rate and lower power consumption than conventional heating wires because they generate heat by area, which can reduce power consumption by 20 to 40% and are used quite usefully because they generate almost no harmful electromagnetic waves and have high smoothness and durability.

Due to these various usefulness, the planar heating elements are used in various fields such as heating mattresses, insulating materials, blankets, building walls, inside partitions, and heating devices in houses for heating purposes, or installed on vehicle windows for frost prevention.

In addition, planar heating elements are also used in agricultural facilities such as vinyl greenhouses, and various anti-freeze devices that melt snow or prevent freezing on roads or parking lots.

Furthermore, planar heating elements are also applied to surfaces of freezer display cases, window systems, bathroom mirrors, home appliances, and sporting goods such as goggles.

In these conventional planar heating elements, positive and negative conductors are usually positioned at a set interval on both sides of a glass plate, and the positive and negative conductors are made to conduct current, and a carbon heater is positioned between the positive and negative conductors.

Accordingly, it is configured to obtain thermal energy by causing the carbon heater to heat up due to the electric energy applied to the positive and negative conductors.

However, the carbon heating unit applied to the conventional planar heating elements has a problem in that the electrical characteristics and electrical stability are not excellent because the contact surface area between the electric path formed by silver paste and the carbon carbon heating unit is not wide.

A prior art document related to the technical field to which the present invention belongs is Republic of Korea Laid-open No. 10-1994-0003420.

### DISCLOSURE

### Technical Problem

The purpose of the present invention is to provide a method for preparing a planar heating element and a planar heating element prepared by the method, which can form a heating layer with excellent electrical characteristics by coating a glass plate with carbon nanotube (CNT) ink and can improve electrical stability by increasing the contact surface area with an electrical path through a heating layer with the small physical properties of particles, while minimizing contact resistance with an electric wire.

Further, the purpose of the present invention is to provide a method for preparing a planar heating element and a planar heating element prepared by the method, which can quickly and safely deposit a heating layer on a glass plate by heating the glass plate to immediately evaporate moisture contained in the carbon nanotube (CNT) during the process of forming a heating layer by coating the glass plate with the carbon nanotube (CNT) ink.

### Technical Solution

The method for preparing a planar heating element according to one embodiment of the present invention comprises the perforating step of drilling at least one hole in a cut glass plate for protruding a wire; the printing step of printing conductive materials for allowing current to flow on the glass plate; and the coating step of coating a heating layer that generates heat by the current on the glass plate.

In addition, the method further comprises, before the perforating step, the polishing step of polishing each edge and each corner of the glass plate before the perforating step; and the washing and drying step of washing and drying the glass plate.

Additionally, the conductive materials are formed of one selected from silver paste, silver nano ink, carbon paste, and carbon nanotubes.

In addition, he method further comprises, between the printing step and the coating step, the heat treating step of heat-treating the glass plate to strengthen the glass plate while the conductive materials are deposited on the glass plate; and the cooling step of cooling the glass plate.

And, the coating step is a step of forming a heating layer by heating the glass plate with a heating and coating device and then applying carbon nanotube (CNT) ink on the glass plate and conductive materials.

Further, the heating and coating device comprises: a heating unit including a heating source that operates to heat and evaporate moisture contained in the carbon nanotube (CNT) ink, on which at least one of the glass plates are mounted; reciprocating driving units disposed on one side and the other side, respectively, of the heating unit; a trolley reciprocally traveling above the glass plate located in the heating unit by the reciprocating driving units; and at least one spray unit mounted on the trolley and spraying the carbon nanotube (CNT) ink onto the glass plate.

Further, the method further comprises, after the coating step, the attachment step of connecting wires to the respective conductive materials and then attaching a protective glass having at least one of a picture, a text, or a logo printed on the surface of the glass plate using a PVB film.

The planar heating element according to one embodiment of the present invention comprises a glass plate on which an electrode is formed; and a heating layer on which carbon nanotube (CNT) ink is coated on the glass plate to generate heat by current conduction, in which the heating layer is formed by a heating and coating device including: a heating unit including a heating unit on which the glass plate is mounted; reciprocating driving units disposed on one side and the other side, respectively, of the heating unit; a trolley reciprocally traveling above the glass plate located in the heating unit by the reciprocating driving units; and at least one spray unit mounted on the trolley and spraying the carbon nanotube (CNT) ink onto the glass plate, and the carbon nanotube (CNT) ink is formed into the heating layer by evaporating moisture contained therein when the glass plate is heated or the ink is sprayed simultaneously with heating.

In addition, the planar heating element further comprises protective glass attached to the glass plate and having at least one of a picture, a text, and a logo printed thereon.

### Advantageous Effects

The method for preparing a planar heating element according to the present invention and the planar heating element prepared by the method have the effect of forming a heating layer with excellent electrical characteristics by coating a glass plate with carbon nanotube (CNT) ink and improving electrical stability by increasing the contact surface area with an electrical path through a heating layer with the small physical properties of carbon particles, while minimizing contact resistance with an electric wire.

Further, they have the effect of quickly and safely depositing a heating layer on a glass plate by heating the glass plate to immediately evaporate moisture contained in the carbon nanotube (CNT) during the process of forming a heating layer by coating the glass plate with the carbon nanotube (CNT) ink.

### DESCRIPTION OF DRAWINGS

FIG. 1 is a block diagram showing the sequence of a method for preparing a planar heating element according to one embodiment of the present invention.

FIG. 2 is a side view showing a process of washing and drying a glass plate through a washing and drying device applied to a method for preparing a planar heating element according to one embodiment of the present invention.

FIG. 3 is a front view showing a heat treating device and a cooling device applied to a method for preparing a planar heating element according to one embodiment of the present invention.

FIG. 4 is a front view showing a heating and coating device applied to a method for preparing a planar heating element according to one embodiment of the present invention.

FIG. 5 is a cross-sectional view showing a state in which conductive materials, a heating layer, and a protective glass are laminated on a glass plate applied to a method for preparing a planar heating element according to one embodiment of the present invention.

FIG. 6 is a front view showing a state in which conductive materials, a heating layer, a wire, and a protective glass are applied to a glass plate applied to a method for preparing a planar heating element according to one embodiment of the present invention.

### MODE FOR INVENTION

Advantages and characteristics of the present invention, and methods for achieving them become clear with reference to the embodiments described later in detail.

However, the present invention is not limited to the embodiments disclosed below, but may be implemented in various different forms, only these embodiments are provided to make the disclosure of the present invention complete and completely inform those skilled in the art of the scope of the invention to which the present invention pertains, and the present invention is only defined by the scope of the claims. Like reference numbers designate like elements throughout the specification.

Hereinafter, embodiments of the present invention are described in detail with reference to the accompanying drawings so that those skilled in the art can easily carry out the present invention. However, the present invention may be embodied in many different forms and is not limited to the embodiments described herein. Like reference numerals have been assigned to like elements throughout the specification.

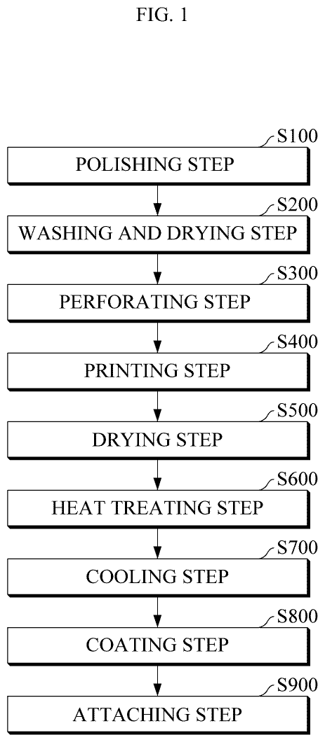

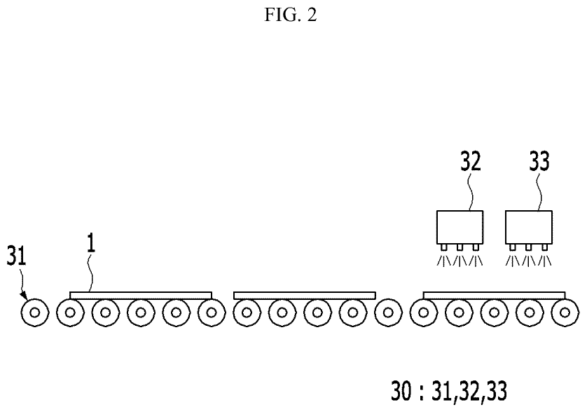

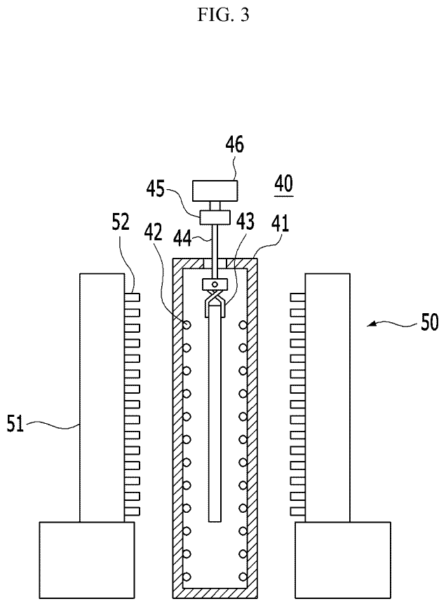

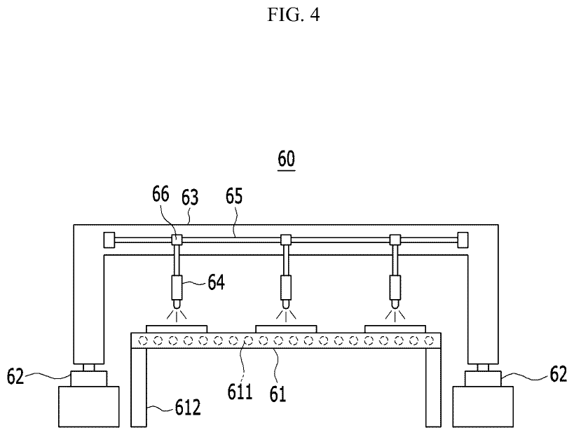

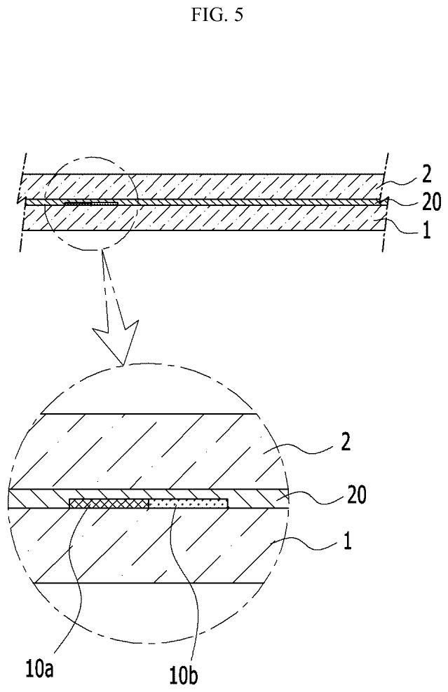

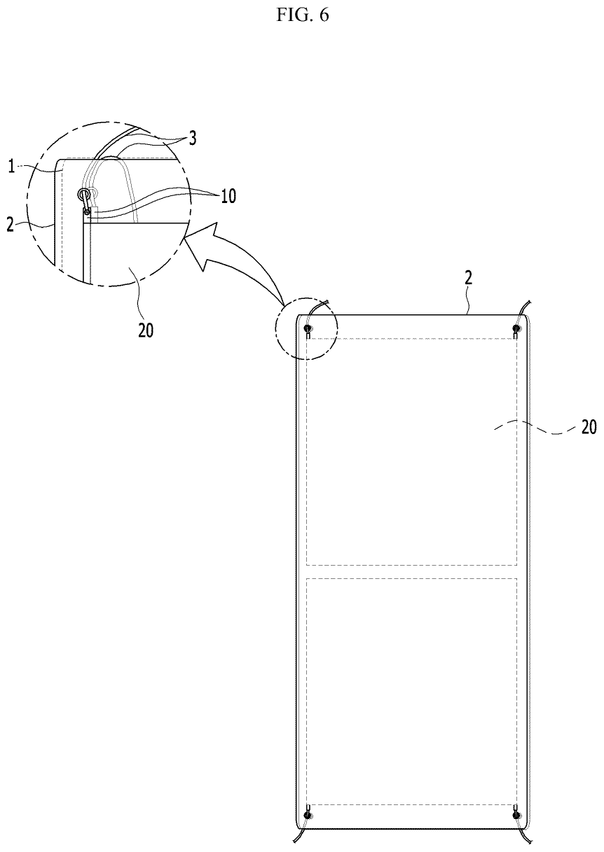

FIG. 1 is a block diagram showing the sequence of a method for preparing a planar heating element according to one embodiment of the present invention, FIG. 2 is a side view showing a process of washing and drying a glass plate through a washing and drying device applied to a method for preparing a planar heating element according to one embodiment of the present invention, FIG. 3 is a front view showing a heat treating device and a cooling device applied to a method for preparing a planar heating element according to one embodiment of the present invention, FIG. 4 is a front view showing a heating and coating device applied to a method for preparing a planar heating element according to one embodiment of the present invention, FIG. 5 is a cross-sectional view showing a state in which conductive materials, a heating layer, and a protective glass are laminated on a glass plate applied to a method for preparing a planar heating element according to one embodiment of the present invention, and FIG. 6 is a front view showing a state in which conductive materials, a heating layer, a wire, and a protective glass are applied to a glass plate applied to a method for preparing a planar heating element according to one embodiment of the present invention.

The method for preparing a planar heating element according to the present invention may comprise at least one of: the polishing step of polishing a glass plate (1), the washing and drying step of washing and drying the glass plate (1), the perforating step of perforating the glass plate (1), the printing step of printing a conductive material (10a, 10b) on the glass plate (1), the heat treating step of heat-treating the glass plate (1), the cooling step of cooling the heat-treated glass plate (1), and the coating step of coating a carbon nanotube (hereinafter referred to as “CNT”) heat-generating ink, which is a heating layer (20), on the glass plate (1) and the conductive material (10a, 10b) printed on the glass plate (1).

First, the polishing step (S100) is a step of polishing the glass plate (1) cut to a certain size.

Specifically, in the polishing step, each edge and each corner of the glass plate (1) is polished using a polishing device such as a grinder, thereby smoothing the sharp surface, rough surface, and pointed surface of the glass plate (1).

At this time, the glass plate (1) may be formed of tempered glass.

In this way, by polishing each edge and each corner of the glass plate (1), the worker's hands can be prevented from being cut during the process of manufacturing the planar heating element.

Meanwhile, after the polishing step, the washing and drying step (S200) is performed.

The washing and drying step is a step of removing dust and other foreign substances on the surface of the glass.

The washing and drying step is performed using a washing and drying device (30).

As shown in FIG. 2, the washing and drying device (30) may include a washing unit (32) and a drying unit (33).

The washing unit (32) and the drying unit (33) are arranged parallel to each other on the upper side of a conveyor (31) that transports the glass plate (1).

The glass plate (1) is transported by the conveyor (31) and passes through the washing unit (32) and the drying unit (33) sequentially.

The washing unit (32) is configured to spray washing water toward the glass plate (1) from the upper side of the conveyor (31).

In addition, the drying unit (33) is arranged at the rear of the washing unit (32) and is configured to spray warm air toward the glass plate (1) from the upper side of the conveyor (31). In other words, the washing water sprayed from the washing unit (32) may remove dust and other foreign substances on the surface of the glass plate (1), and the warm air sprayed from the drying unit (33) may dry moisture on the surface of the glass plate (1).

In this way, after washing and drying the upper surface of the glass plate (1) using the washing and drying device (30), the glass plate (1) is turned over 180 degrees and placed on the conveyor (31) so that the bottom of the glass plate (1) is turned to the upper surface, and then it is washed and dried through the washing unit (32) and the drying unit (33).

Meanwhile, after the washing and drying step, the perforating step (S300) is performed.

The perforating step is the step of drilling a pair of holes (1a) in the glass plate (1) that has undergone the polishing step through which a pair of wires (3) pass.

At this time, a pair of holes (1a) are performed on the line where the conductive materials (10a, 10b) are printed on the glass plate (1).

The drawing shows an example in which conductive materials (10a, 10b) are printed on the right and left edges of the glass plate (1), and holes (1a) are also drilled on the right and left edge lines of the glass plate (1), respectively.

For example, the perforation of the glass plate (1) can be performed using an electric drill. The electric drill may be automatically raised and lowered relative to the glass plate (1) using a lifting device such as a cylinder or cam.

After the glass plate (1) is placed on the upper surface of the work table, the electric drill is lowered toward the glass plate (1) using a lifting device such as a cylinder or cam, thereby drilling holes (1a) in the glass plate (1) for protruding wires (3).

At this time, the wires (3) can be applied as a pair of wires, with a positive pole and a negative pole. Further, since the conductive materials (10a, 10b) described below are printed in two lines each on one side and the other side of the glass plate (1), the wires (3) are applied as two pairs in total and are electrically connected to the conductive materials (10a, 10b) arranged on one side and the other side of the glass plate (1).

The method of connecting the wires (3) to the conductive materials (10a, 10b) respectively is a commercialized technology in the field of planar heating elements, so a detailed description is excluded.

Meanwhile, after the perforating step, the printing step (S400) is performed.

The printing step is a step of printing the conductive materials (10a, 10b) to allow electricity to flow through the glass plate (1).

The conductive materials (10a, 10b) are connected to the (+) electrode and the (-) electrode, that is, the aforementioned wires (3), respectively, so that electricity flows, thereby generating heat.

The conductive materials (10a, 10b) may be formed of silver paste.

The conductive materials (10a, 10b) are in the form of ink and are printed in the form of lines of a certain length on one side and the other side of the glass plate (1) to form an electric path.

Further, the conductive materials (10a, 10b) allow current to flow on the surface of the glass plate (1) and generate heat that can sufficiently heat the heating layer (20).

The method of printing the conductive materials (10a, 10b) may use at least one of screen printing, offset printing, gravure printing, flexo printing, letterpress printing, inkjet printing, and roll-to-roll gravure printing, but is not limited thereto.

At this time, the electric path may mean a line printed with the conductive materials (10a, 10b) or may mean a pattern by a line. For the electric path, the resistance value may be adjusted to set the heating temperature, and the resistance value of the heating element can be adjusted according to the heat treatment conditions and the conditions of the conductive materials (10a, 10b).

In addition, in the method for manufacturing a planar heating element according to one embodiment of the present invention, it is disclosed that the conductive material (10a, 10b) is not limited to silver paste and can be formed of any one selected from silver nano ink, carbon paste, and carbon nanotubes.

Meanwhile, the conductive materials (10a, 10b) can be transparent conductive electrode materials having high transmittance. As transparent conductive materials, antimony-containing tin oxide (antimony tin oxide, ATO) or indium-containing tin oxide (indium tin oxide; hereinafter referred to as ‘ITO’) may be used.

Meanwhile, after the printing step, the drying step (S500) is performed to dry the glass plate (1).

The drying step may be performed using equipment that generates warm air or hot air, or by naturally drying the glass plate (1) in a drying room.

Through this drying step, the conductive materials (10a, 10b) can be dried and fixed on the glass plate (1).

And, when the conductive materials (10a, 10b) are dried, the conductive materials (10a, 10b) create a path through which electricity can flow.

Meanwhile, after the drying step, the heat treating step (S600) is performed to improve the strength of the glass plate (1) while depositing (fixing) a conductive material (10a, 10b) on the glass plate (1).

The heat treating step may be performed by a heat treating device (40).

The heat treating device (40) includes a chamber (41) and a heating means (42).

The chamber (41) has an entrance formed on one side through which a glass plate (1) enters and exits, and an accommodation space formed inside in which the glass plate (1) is received.

The heating means (42) are respectively arranged on both sides of the inner wall of the chamber (41) and face each other with the glass plate (1) in between. The heating means (42) can be applied as a product capable of generating heat, such as a heater or a heating wire.

The glass plate (1) can enter and exit the chamber (41) while being held by a plurality of grippers (43).

Each of the grippers (43) is connected with a vertical bar (44) having a certain length.

The upper sides of the vertical bars (44) are fixed together to a single horizontal frame (45).

Then, the horizontal frame (45) is horizontally reciprocated by a transport device (46) to transfer the glass plate (1) held by the grippers (43) to the inside or outside of the chamber (41).

For example, the transport device (46) may include a pair of rotating bodies arranged so as to be spaced apart from each other and a rotating member that rotates in a forward or reverse direction while forming an endless track on the pair of rotating bodies.

The rotating body may be formed as a pulley or a sprocket.

The rotating member is formed as a timing belt when the rotating body is formed as a pulley, and is formed as a chain when the rotating body is formed as a sprocket.

Either one of the pair of rotating bodies is rotated in a forward or reverse direction by the power of the motor.

In addition, a horizontal frame (45) is coupled to the rotating member.

Therefore, when the rotating bodies are rotated in a forward or reverse direction by the motor, the rotating member rotates in response to the rotational direction of the motor. Ultimately, the rotational direction of the rotating bodies can be controlled through the motor to transport the glass plate (1) into or out of the chamber (41).

The glass plate (1) transported into the internal space of the chamber (41) is heat-treated through the heating operation of a heater or a heating wire.

At this time, the heat treatment temperature of the glass plate (1) through the heater or heating wire in the heat treating step may be about 700° C. to 900° C., but is not limited thereto.

When the glass plate (1) is heat-treated in this manner, conductive materials (10a, 10b) (silver paste) are deposited on the glass plate (1). And, the deposited conductive materials (10a, 10b) serve as an electric path through which the wire (3) can supply electricity to the glass plate (1) in the soldering process that is performed later.

In addition, the glass plate (1) can be strengthened to a certain level by the heat treatment to secure structural stability.

As a result, the glass plate (1) can be prevented from being damaged by various impacts or strong winds.

At this time, it is disclosed that the transport device (46) in the present invention is not limited to the aforementioned rotating body and rotating member and may be replaced with any one selected from a rodless cylinder, a linear cylinder, and a rack and pinion.

Meanwhile, after the heat treating step, the cooling step (S700) is performed.

The cooling step is a step of cooling the heat-treated glass plate (1) to a certain temperature or higher.

The cooling step may be performed by a cooling device (50).

The cooling device (50) includes a pair of plates arranged opposite each other on the entrance side of the chamber (41), a plurality of spray nozzles (52) arranged to be spaced apart from each other in the vertical and horizontal directions from the flat plate (51) and capable of spraying cold air toward the glass plate (1), and an air compressor (not shown) supplying compressed air to the spray nozzles (52).

Therefore, the glass plate (1) taken out from the chamber (41) by completing the heat treating step is positioned between the flat plates (51), and the spray nozzles (52) face the glass plate (1).

The spray nozzles (52) have a certain area embedded in the inside of the flat plate (51), and the remaining area protrudes from the flat plate (51) to face the glass plate (1).

And, branch pipes (not shown) connected to the spray nozzles (52) are embedded inside the flat plate (51).

The branch pipes are configured so that their internal parts are interconnected.

One side of the branch pipe is connected to a supply pipe (not shown) connected to the air compressor.

Accordingly, when the glass plate (1) is positioned between the flat plates (51), and the air compressor is operated, the cold air generated from the air compressor is evenly sprayed onto the glass plate (1) through the spray nozzles (52).

Meanwhile, after the cooling step, the taping step may be performed.

The taping step is a step of attaching a tape along the edge of the glass plate (1) to prevent CNT ink from being applied to the edge of the glass plate (1) in the subsequent coating step.

After applying CNT ink to the glass plate (1) and drying it, the tape is removed from the glass plate (1), a PVB film is attached to the edge of the glass plate (1), and then a protective film is attached.

Meanwhile, after the taping step, the coating step (S800) is performed.

The coating step is a step of forming a heating layer (20) by spraying the CNT ink on the glass plate (1) and the electrical path, which is a conductive material (10a, 10b) printed on the glass plate (1).

CNT is a long carbon structure in the shape of a honeycomb, with a cylinder diameter of several tens of nanometers, and hexagons made of six carbon atoms are connected to each other to form a tube shape. CNT has similar electrical conductivity to copper, has the characteristic of generating heat when electricity is applied, and has excellent electrical and mechanical properties.

In addition, CNT has smaller carbon particles than conventional carbon-based heat-generating ink to increase the contact surface area with the electric path formed by the conductive material (10a, 10b), and accordingly, the microscopic space formed at the contact portion between the heating layer (20) and the glass plate (1) and the contact portion between the heating layer (20) and the electric path can be reduced, thereby improving electrical stability.

Further, in this coating step, the CNT ink with carbon particles as small as tens of nanometers is applied to the glass plate (1) to increase the contact surface area, thereby providing an effect of minimizing the contact resistance with the wire (3).

The heating and coating device (60) is used to coat the CNT ink described above on the glass plate (1).

That is, the coating step is performed by automatically heating the glass plate (1) through the heating and coating device (60), and then automatically applying the CNT ink to the glass plate (1) and the electric path.

As shown in FIG. 4, the heating and coating device (60) includes a heating unit (61), a reciprocating driving units (62), a trolley (63), and a spray unit (64).

The heating unit (61) may be formed in a flat plate shape.

Support legs (612) are attached to both sides of the bottom surface of the heating unit (61).

Therefore, the heating unit (61) supports the glass plate (1) at a predetermined distance from the ground.

At least one glass plate (1) is placed on the upper surface of the heating unit (61).

The heating source (611) that generates heat to evaporate moisture contained in the CNT ink is embedded inside the heating unit (61).

The heating source (611) may be applied as a product that generates heat by receiving power, such as a heating wire or a heating coil.

The heating source (611) can be embedded in a sine wave pattern, a sawtooth wave pattern, etc. to evenly heat the entire heating unit (61).

The heating part (61) can be formed of a material with excellent thermal conductivity, such as a metal, to evenly transfer the heat generated by the heating source (611) to the glass plate (1).

The reciprocating driving units (62) are composed of a pair of two parts and is arranged on one side and the other side of the heating unit (61), respectively.

The reciprocating driving units (62) can be formed by any one of a pneumatic cylinder, such as a rodless cylinder or a liner cylinder, or a rack and pinion, so that the trolley (63) and the spray unit (64) can move along the glass plate (1), and an example formed by a pneumatic cylinder is shown in the drawing.

The trolley (63) can be formed in a cross-sectional shape that is approximately the letter ‘U’.

Both sides of the bottom of the trolley (63) are respectively connected to the piston of the reciprocating driving unit (62).

Therefore, the trolley (63) and the spray unit (64) mounted on the trolley (63) are moved along the upper surface of the glass plate (1) by the reciprocating driving unit (62).

The spray unit (64) is mounted on the trolley (63) and moves along the upper surface of the glass plate (1) to spray CNT ink.

A storage tank (not shown) storing CNT ink to be supplied to the spray unit (64) may be installed on the trolley (63).

At this time, the spray unit (64) is applied as a product of the type that sprays compressed air, so that the CNT ink can be evenly sprayed on the glass plate (1), and ultimately, a heating layer (20) of uniform thickness can be formed on the glass plate (1).

As described above, since one or two or more glass plates (1) can be installed on the heating unit (61), so the number of spray units (64) can be applied in a number corresponding to the number of glass plates (1).

By applying multiple spray units (64), it is possible to spray CNT ink on multiple glass plates (1) at once to form a heating layer (20).

Furthermore, the spray units (64) can be implemented so that their positions are adjusted to correspond to the gap between the glass plates (1).

To this end, a rail unit (65) is installed horizontally on the trolley (63), and a slider (66) that slides left and right along the rail unit (65) is installed on the spray unit (64), so that the spray unit (64) and the glass plate (1) can be vertically opposed to each other 1:1.

In the coating step described above, the glass plate (1) is preheated by the heating unit (61), and then the CNT ink is automatically and evenly applied through the spray unit (64), so that the moisture contained in the CNT ink can be immediately evaporated. Therefore, only the CNT ink may be quickly and stably deposited and fixed on the glass plate (1).

Accordingly, the process of drying the CNT ink applied to the glass plate (1) can be omitted, thereby shortening the time required to preparing the planar heating element.

Further, the phenomenon of the CNT ink spreading during the process of removing the glass plate (1) that has undergone the coating step from the heating unit (61) may also be prevented.

In addition, the heating temperature of the glass plate (1) by the heating source (611) in the coating step may be about 100° C. to 150 ° C., but it is noted that the heating temperature of the glass plate (1) in the present invention is not limited to the temperature range described above.

The heating temperature of the glass plate (1) can be selectively changed depending on the size of the glass plate (1), the properties of the CNT ink, the amount of the CNT ink, and other various conditions.

Meanwhile, after printing the CNT ink on the glass plate (1), wires (3) are respectively connected to the electric paths formed by the conductive materials (10a, 10b) on the glass plate (1).

At this time, the electric path may be formed only on the front surface of the glass plate (1). Further, the wires (3) can be fixed to the electric paths by a process of soldering by penetrating the hole (1a) formed in the glass plate (1) by the perforating step from the rear surface of the glass plate (1).

The method of connecting the wires (3) to the electric paths is a commercialized technology in the field of planar heating element technology, so a detailed description is omitted.

Meanwhile, after connecting the wires (3) to the electric paths of the glass plate (1), the attachment step (S900) of attaching a protective glass (2) to the front surface of the glass plate (1) is performed.

The protective glass (2) may be attached to the glass plate (1) through a polyvinyl butyral (PVB) bonding film.

As described above, the polyvinyl butyral (PVB) bonding film can be attached to the edge area of the glass plate (1).

As another example, the polyvinyl butyral (PVB) bonding film may be attached not only to the edge area of the glass plate (1) but also to the inner area of the edge.

At this time, the attachment of the glass plate (1) and the protective glass (2) can be accomplished through a vacuum pressing device.

For example, after attaching the polyvinyl butyral (PVB) bonding film to the glass plate (1), the protective glass (2) is placed on top of it, and then the glass plate (1) and the protective glass (2) are pressed for about 2 to 3 hours through a vacuum pressing device, thereby attaching the protective glass (2) to the glass plate (1).

The conventional planar heating element was used by soldering the wire (3) to the end of the electric path of the glass plate (1) without the protective glass (2), but in this case, the problem of the wire (3) being easily broken occurred because it was exposed.

However, the method for preparing the planar heating element according to the present invention can prevent the wire (3) from being cut off and prevent the electric path or heating layer (20) from being damaged by completely covering and protecting the electric path, wire (3) and heating layer (20) by attaching the protective glass (2) to the glass plate (1).

In addition, the protective glass (2) can be formed of the same material as the glass plate (1).

The protective glass (2) may be printed with pictures, patterns, etc. for decoration, and the manufacturer's name, manufacturer's logo, texts, etc. for promotion may be further printed.

Further, at least one of the polishing step, the washing and drying step, and the heat treating step may also be performed on the protective glass (2).

Those skilled in the art to which the present invention pertains understand that the present invention can be embodied in other specific forms without changing its technical spirit or essential features. Therefore, the embodiments described above should be understood as illustrative in all respects and not limiting. It should be interpreted that the scope of the present invention is indicated by the claims to be described later rather than the detailed description above, and all changes or modifications derived from the meaning and scope of the claims and equivalent concepts thereof are included in the scope of the present invention.

1. A method for preparing a planar heating element, comprising:
printing step of printing conductive materials for causing current to flow on a glass plate; and
coating step of applying carbon nanotube (CNT) ink on the glass plate and the conductive material to form a heating layer that generates heat by current conduction while heating the printed glass plate with a heating and coating device.

2. The method of claim 1, wherein the heating and coating device comprises:
a heating unit including a heating source that operates to heat and evaporate moisture contained in the carbon nanotube (CNT) ink, on which at least one of the glass plates are mounted;
reciprocating driving units disposed on one side and the other side, respectively, of the heating unit;
a trolley reciprocally traveling above the glass plate located in the heating unit by the reciprocating driving units; and
at least one spray unit mounted on the trolley and spraying the carbon nanotube (CNT) ink onto the glass plate.

3. The method of claim 1, further comprising: after the coating step, attachment step of connecting wires to the respective conductive materials and then attaching a protective glass having at least one of a picture, a text, or a logo printed on the glass plate using a PVB film.

4. A planar heating element comprising: a glass plate on which an electrode is formed; and
a heating layer on which carbon nanotube (CNT) ink is coated on the glass plate to generate heat by current conduction;
wherein the heating layer is formed by a heating and coating device including:
a heating unit including a heating unit on which the glass plate is mounted; reciprocating driving units disposed on one side and the other side, respectively, of the heating unit; a trolley reciprocally traveling above the glass plate located in the heating unit by the reciprocating driving units; and at least one spray unit mounted on the trolley and spraying the carbon nanotube (CNT) ink onto the glass plate, and
wherein the carbon nanotube (CNT) ink is formed into the heating layer by evaporating moisture contained therein when the glass plate is heated or the ink is sprayed simultaneously with heating.

5. The planar heating element of claim 4, further comprising: a protective glass attached to the glass plate and having at least one of a picture, a text, and a logo printed thereon.
